(19) United States
(12) Patent Application Publication
(10) Pub. No.: US 2003/0035552 A1
(43) Pub. Date: Feb. 20, 2003

(54) Process and system for directional acoustic propagation

(76) Inventors: Guido Kolano, Salach, DE (US); Klaus Linhard, Schelklingen (DE)

Correspondence Address: Stephan A. Pendorf, Pendorf & Cutliff, P.O. Box 20445, Tampa, FL, 33622-0445, US

(21) Appl. No.: 10/223,159

(22) Filed: Aug. 18, 2002

(30) Foreign Application Priority Data
Aug. 18, 2001 (DE) 101 40 646.0-35

(51) Int. Cl. H04B 3/00; H04B 5/00

(52) U.S. Cl. 381/77; 381/79

(57) ABSTRACT

A process and a device for producing a directed audio sound (3) on the basis of an amplitude demodulated ultrasound carrier signal (2) of high intensity. Therein, in accordance with the invention, the sound emitted by the ultrasound emitter (1) is reflected by a reflector (5) to a new direction. By appropriate shaping of the reflector surface, the audio sound (3) can be focused. The level of the ultrasound carrier signal (2) can be dampened by coating of the reflector (5) with an appropriate absorptive material, so that in the ideal case only the acoustic audio signal (3) reaches of the listener (4).

### BACKGROUND OF THE INVENTION

1. Field of the Invention

The invention is concerned with systems with which an acoustic signal (for example audio, music) can be produced. In particular, the invention concerns systems with which acoustic signals can be propagated highly directionally.

2. Description of the Related Art

Conventional systems, wherein the audio signal is emitted directly as air oscillations via individual loudspeakers or via a loudspeaker array, can achieve only a relatively limited directionality of the sound emissions. In a new process, in comparison, the audio-signal is not produced directly, but rather as a change in amplitude (amplitude modulation, AM) of a carrier oscillation of very high frequency emission (ultrasonic). The underlying physical phenomenon of the acoustic realization of sum and difference waves as a consequence of nonlinear characteristics of air were already recognized and studied by the physicist Helmholtz in the 19^{th} century. The application of the physical principles for the development of an ultrasonic/audio-loudspeaker were described by Yoneyama, Fukimoto, Kawamo and Sasabe in “The audio spotlight: An application of nonlinear interaction of sound waves to a new type of loudspeaker design”, in Journal of the Acoustic Society of America, 1983, pages 1532-1536.

An ultrasonic/audio-loudspeaker produces first a carrier signal with a frequency, which lies above the upper audio range of humans, that is, in the ultrasound range. For producing audible sound oscillations the carrier signal is amplitude-modulated with an overlying audio signal. Since the ultrasound carrier signal itself is not audible, it can be emitted with high sound pressure. With this high sound pressure the air behaves in a nonlinear fashion and thus acts as a demodulator, which demodulates the AM-signal and therewith produces the audio signal again as air oscillations in the audible range. Since the audible audio signal is first produced in the air medium itself, it increases in audio intensity with increasing distance from the emitter (ultrasonic loudspeaker), first continuously increasing, and then as a consequence of absorption by air begins to decrease with increasing distance.

Therein, the sideways spatially spreading perpendicular to the direction of propagation or, as the case may, be directionality of the generated audio signal, is dependent upon the directionality of the ultrasound carrier signal (angle of opening of the emitted ultrasound wedge) and is somewhat greater than for ultrasound. This can lead, particularly in confined spatial areas (vehicle cabins) to undesired reflections from objects. Further, the acoustic limitation to only one specific listener (for example, for the selection of differnent audio programs for different individual occupants of the vehicle) is hardly achievable due to the lateral broadening of the audio signal.

It is fundamental to such systems with modulated ultrasound signal, that a certain distance from the emitter is necessary in order to produce audible signals. The distance can, in practical systems, lie in the range of approximately 20 cm to approximately 1 m, so that employment in confined spatial areas (for example in vehicles) may result in particular technical problems (maintaining the minimum distance between ultrasound speaker and listener, good balancing of the audio sound for the respective listeners, etc.).

From DE 196 28 849 A1 a directional emitter is known, which is provided with a parabolic reflector, in order to impinge the listener with directional or collimated sound. The emitter is herein oriented directed towards the listener.

A system for targeted acoustic irradiation of selected areas within a total area is described in DE 42 30 362 A1. Herein an ultrasound carrier signal modulated with an audio signal is emitted directed towards a listener using a group of loudspeakers.

A further disadvantage is based on the requirement that the ultrasound carrier signal must be emitted with high intensity, since only in the presence of high sound pressure can nonlinear characteristics occur in the air, as required for the demodulation of the audio signal. With practical systems for the production of audio sound of low to medium sound intensity an ultrasound level of approximately 130 dB (A) is already necessary. The conventional level for audible sound (music, audio) lies, in comparison thereto, in the range of approximately 30 to 90 dB (A). The possible adverse health effects of very high ultrasound levels on humans has not yet been conclusively researched. Particularly in the case of employment in vehicles (where among other things also multiple ultrasound emitters may be active at the same time in order to provide for various occupants with different audio channels or signals) the high ultrasound levels could possibly lead to undesired side effects.

### SUMMARY OF THE INVENTION

Beginning from this state of the art the present invention is concerned with the task of providing an improved process and system for directed emission of audio sound on the basis of modulated ultrasound, which invention largely overcomes the above mentioned disadvantages regarding audio sound directionality, necessary distance between emitter and listener, and high ultrasound level.

This task is solved by a process for directed sound irradiation of a listener with audible acoustic audio signals by modulation of the amplitude of an intense ultrasound carrier signal, which is emitted directionally from an ultrasound emitter, wherein the audio sound is directed to the listener via a reflector, wherein the ultrasound carrier signal prior to reaching the listener is attenuated by a means introduced between ultrasound emitter and listener. The corresponding device is characterized by the presence of a reflector is present, which reflects the audio sound in the direction of the listener, and a means introduced between the ultrasound emitter and listener which strongly reduces the intensity of the ultrasound carrier signal prior to reaching the listener.

### BRIEF DESCRIPTION OF THE DRAWINGS

The inventive process and the corresponding device are described in the following on the basis of a preferred embodiment, wherein reference is made to the figures and the therewith associated reference numbers. There is shown:

FIG. 1: a conventional system for directed audio emission by modulation of ultrasound with high level;

FIG. 2: a diagram representing the directionality of the sound emission depending upon the frequency;

FIG. 3: a system according to the inventive process with a reflector between sound source and listener;

FIG. 4: an example of employment of the inventive system in an automobile.

### DETAILED DESCRIPTION OF THE INVENTION

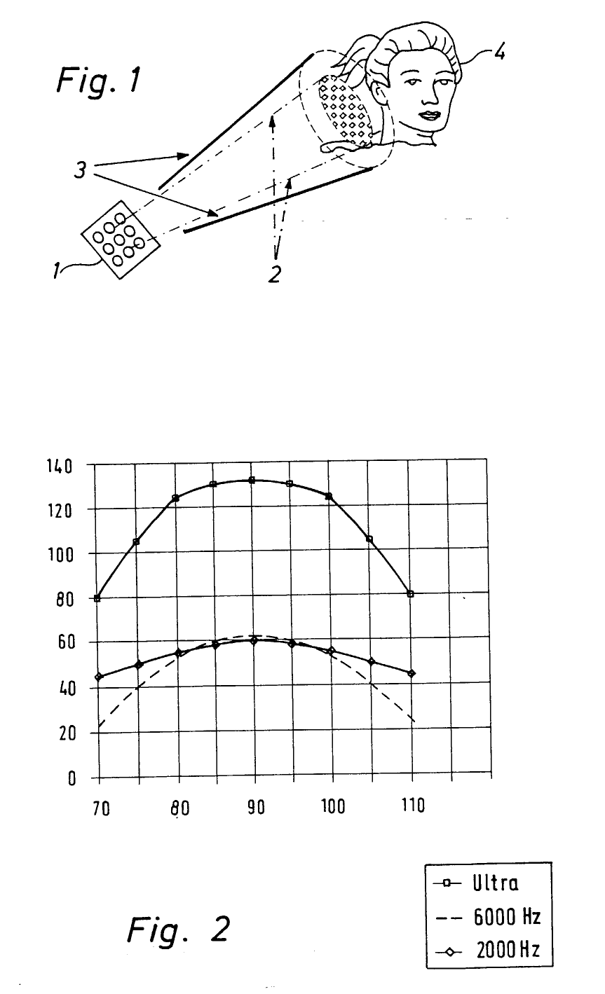

In the inventive process, first in accordance with a conventional system an amplitude modulated ultrasound signal is emitted by an ultrasound emitter, whereby the ultrasound spreads in the shape of a directional sound cone. FIG. 1 schematically shows a device of this type. The ultrasound emitter 1 produces the amplitude modulated carrier signal, which spreads out in the form of a directional ultrasound cone 2. The audible sound 3 is produced by the high sound pressure within the ultrasound cone, likewise in a cone-shaped area. Both sound cones reach the listener 4 located at that distance from the emitter which is necessary for the demodulation of the audio signal.

In general the carrier signal is more strongly directional, that is, the ultrasound cone has, as shown in FIG. 2, a smaller opening or spreading angle in comparison to the area of the audio signal. Therein the different frequencies of the audible audio sound are spatially bundled to different degrees. FIG. 2 shows these spatial distributions of the sound emission depending upon the sound frequency. Represented are measurement results at an ultrasound emitter with a frequency of the carrier signal of 127 kHz and two different frequencies of the audio signal demodulated in the air. In the Y-direction the measured dB-value of the output is indicated, and in the X-direction the emission angle in degrees. The angle of 90 degrees corresponds in this representation to the main direction of the sound emission (axes of the sound cone).

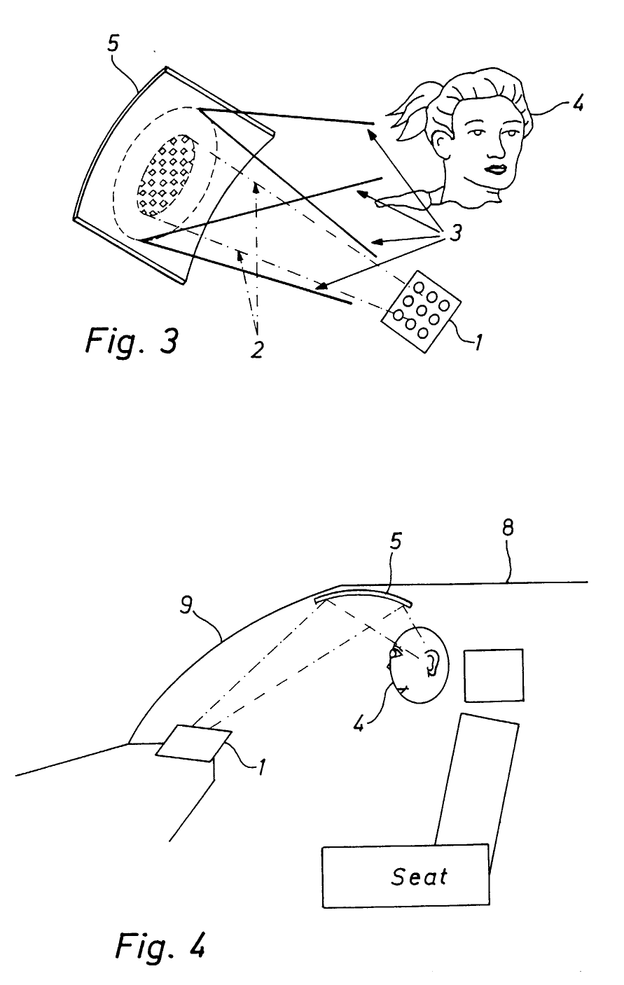

In the inventive process it is thus prevented, that the intense ultrasound carrier signal directly reaches the ear of the listener. For this, a reflector 5 is so introduced in the ultrasound cone 2 at a distance from the ultrasound emitter 1, that the sound is redirected in a new direction. FIG. 3 shows a corresponding arrangement, wherein the sound cone of the ultrasound signal 2 and the sound cone of the audio signal 3 are represented.

The inventive process has the advantage that the audio signal 3, as it continues with it's propagation from the reflector 5 to the listener 4, can be directed. This occurs preferably by appropriate contouring or shaping of the reflector 5, which is in the form of, for example, a concave surface (spherical surface). Thereby even in confined spaces (vehicles) a good bundling of the reflected sound 3 to a narrowly confined spatial area (head area of the individual listener) can be achieved. In the ideal case only the ear of the respective listener is reached, in order to avoid further reflections from the head of the listener.

As a result the reflection there is the further advantage that the necessary minimal distance for achieving the demodulated audio signal 3 no longer requires a direct or linear open distance between ultrasound emitter 1 and listener 4, but rather can, by the appropriate diagonal positioning of the reflector 5, be also so detoured, that a smaller installation space—as available, for example, in a vehicle—is sufficient. In a different embodiment multiple reflectors 5 can be arranged sequentially, and sequentially convey sound, so that the necessary distancing can be achieved by multiple reflections (not shown).

A particular advantage is comprised in the possibility, that the audio signal 3 can be separated from the ultrasound carrier signal 2. If the path from the ultrasound emitter 1 to the reflector 5 is sufficiently long, in order to produce the audio signal 3 in air, then the ultrasound carrier signal 2 is no longer needed. Therewith the (intensive) ultrasound carrier signal can be attenuated, so that the ultrasound no longer reaches the listener 4, or reaches the listener 4 only after strong attenuation. For this, a means can be introduced in the sound cone for selectively filtering or suppressing the ultrasound carrier signal 2.

In the preferred embodiment the reflector 5 is so arranged, that it produces or exhibits selective reflection characteristics: the ultrasound 2 is significantly reduced in power as a result of absorption at its high frequency, while the lower frequency audio signal 3, in comparison thereto, is reflected almost without any weakening. Such a selective sound insulation or dampening at the reflector 5 can be achieved for example by providing an ultrasound absorbing coating on the reflector. For this, there suffices a for example fine porous material. In the simplest case a thin grill or baffle cloth can be stretched over it. The ultrasound absorbing layer can have a smaller surface than the total reflector surface, in the case that the ultrasound is appropriately narrowly collumated and therewith only impinges upon a part of the reflector surface, while the audio sound signal is, among other things, more spread out.

The inventive process is in particular suitable for employment in smaller spaces, for example vehicles. FIG. 4 shows schematically the installation or incorporation of the appropriate reflector systems in a vehicle. In this illustrative embodiment the ultrasound emitter 1 is incorporated in the dashboard 6. Therewith there result good configuration or layout possibilities with regard to the necessary installation depth, which could include among other things the necessary cooling device. The diagonally upwardly directed ultrasound carrier signal 2 shown in this example impinges upon the reflector 5, which is positioned here in the upper area of the windshield 9, for example in the transitional area between the windshield and roof 8 of the vehicle or as an integrated part of the roof 8. By the ultrasound absorbing coating of the reflector 5 the ultrasound carrier signal is strongly dampened, so that practically only the audible audio sound 3 is reflected. The surface curvature of the reflector 5 additionally achieves a focusing of the audio sound 3. The main direction of the reflection is so oriented, that the reflected audio signal 3 reaches the ear of the listener 4. A corresponding adjustment (for example, to conform to individual body size of the listener or to take into consideration adjustment of the seat height) can occur by adjustment devices at the reflector 5 and/or by changing the direction of emission at the ultrasound emitter 1—here in the dashboard.

Basically, the inventive reflector system offers the advantage that all the components of the system which have a greater weight and a corresponding volume can be built into the areas of the vehicle cabin which offer the necessary space. The reflector itself can be relatively thin and be produced from a light-weight material (for example aluminum, plastic, etc.). This is also of advantage for safety aspects, since all heavy components (ultrasound emitter) are shielded by appropriate integration in stable and also deep-lying areas of the vehicle, and thus are shielded in the case of an accident (minimizing the danger of injury in the head area).

In a further embodiment (not shown) the reflector system can be further improved by a safety device, which in the case that an object or a person approaches the area of high ultrasound intensity (ultrasound cone between ultrasound emitter and reflector) an automatic switching off or as the case may be reduction of the ultrasound signal occurs. The recognition of the penetration in the ultrasound cone can occur using proximity detectors in conventional manner as known from the state of the art, for example by infrared or ultrasound detectors.

The described process for directed audio emission is based upon a modulated ultrasound carrier signal and is characterized by low space requirement, high bundling of the audio emission and reduction of the ultrasound impingement upon the listener. It is particularly suitable for employment in small or confined spaces, such as for example in vehicles, whereby, with an appropriate design, differing audio signals can be offered to the different seats, without there being any acoustic overlap.

1. Process for directed sound irradiation of a listener (4) with audible acoustic audio signals (3) by modulation of the amplitude of an intense ultrasound carrier signal (2), which is emitted directionally from an ultrasound emitter (1), thereby characterized, that the audio sound (3) is directed to the listener (4) via a reflector (5), wherein the ultrasound carrier signal (2) prior to reaching the listener (4) is attenuated by a means introduced between ultrasound emitter (1) and listener (4).

2. Process according to claim 1, thereby characterized, that the reflector (5) is utilized as the means for damping.

3. Process according to claim 1 or 2, thereby characterized, that the dampening of the ultrasound carrier signal (2) occurs by absorption.

4. Process according to one of claims 1 through 3, thereby characterized, that the audio sound (3) is refocused by reflection.

5. Process according to one of claims 1 through 4, thereby characterized, that the main direction of emission of the reflected audio signal (3) can be changed by adjustment or pivoting of the reflector (5) and/or the ultrasound emitter (1).

6. Process according to one of claims 1 through 5, thereby characterized, that upon approaching or penetration by an object or a person in the area between ultrasound emitter (1) and reflector (5) the ultrasound carrier signal (2) is switched off or reduced in intensity.

7. Device for the directed sound irradiation of a listener (4) with acoustic recognizable audio signals (3), wherein an ultrasound emitter (1) emits with bundling an amplitude modulated ultrasound carrier signal (2) with high intensity, thereby characterized, that a reflector (5) is present, which reflects the audio sound (3) in the direction of the listener (4), and that between the ultrasound emitter (1) and listener (4) a means is introduced which strongly reduced the intensity of the ultrasound carrier signal (2) prior to reaching the listener (4).

8. Device according to claim 7, thereby characterized, that means for reducing the intensity of the ultrasound carrier signal (2) is a reflector (5).

9. Device according to claim 7 or 8, thereby characterized, that the surface of the reflector (5) exhibits a curvature, in such a manner, that the audio signal (3) is focused in the direction of the listener (4).

10. Device according to claim 9, thereby characterized, that the means reduce the intensity of the ultrasound carrier signal by absorption.

11. Device according to claim 10, thereby characterized, that the means are applied as layer upon the reflecting surface of the reflector (5).

12. Device according to claim 11, thereby characterized, that the layer is applied only to a part of the reflecting surface of the reflector (5).

13. Device according to claim 10, 11 or 12, thereby characterized, that the means is comprised of a fine porous material, for example, cloth.

14. Device according to one of claims 7 through 13, thereby characterized, that positioning or pivoting devices are provided, via which the ultrasound emitter (1) and/or the reflector (5) can be mechanically adjusted, so that the direction of the audio sound (3) is changeable.

15. Device according to one of claims 7 through 14, thereby characterized, that detectors are present, which detect the penetration of an object or person in the area between ultrasound emitter (1) and reflector (5) and produce a reduction in the intensity or as the case may be switching off of the ultrasound carrier signal (2).

16. Use of a device according to according to one of claims 7 through 15 for directed sound irradiation of occupants of a vehicle with audio sound.
